(19) United States
(12) Patent Application Publication
(10) Pub. No.: US 2024/0152788 A1
(43) Pub. Date: May 9, 2024

(54) INFORMATION PROCESSING SYSTEM, INFORMATION PROCESSING METHOD, AND PROGRAM

(71) Applicant: SONY GROUP CORPORATION, TOKYO (JP)

(72) Inventors: KEITARO MACHIDA, TOKYO (JP); ITARU SHIMIZU, TOKYO (JP); SUGURU AOKI, TOKYO (JP)

(21) Appl. No.: 18/550,013

(22) PCT Filed: Jan. 20, 2022
(86) PCT No.: PCT/JP2022/001895

§ 371 Date: Sep. 11, 2023

(30) Foreign Application Priority Data
Mar. 23, 2021 (JP) 2021-048705

(51) Int. Cl. G06N 5/045

(52) U.S. Cl. CPC G06N 5/045

(57) ABSTRACT

The present technology relates to an information processing system, an information processing method, and a program that are capable of facilitating the understanding of an explanation regarding AI processing. The information processing system includes an evaluation portion that evaluates multiple choices according to two or more evaluation criteria based on parameters obtained during a process or a result of machine learning, and an explanation portion that generates explanatory text regarding each of the choices by using a phrase associated with a corresponding one of the evaluation criteria. For example, the present technology is applicable to hardware and software performing various processes with the use of AI.

### TECHNICAL FIELD

The present technology relates to an information processing system, an information processing method, and a program, and particularly to an information processing system, an information processing method, and a program that are preferably used to present an explanation regarding AI (Artificial Intelligence) processing.

### BACKGROUND ART

Recently, the use of AI has been spreading in various fields (e.g., see PTL 1). Moreover, with the spread of AI, a “black box” problem of AI has become a more conspicuous issue, and therefore, explainable AI has been demanded.

For meeting this demand, there is an attempt, for example, to cause such AI to evaluate respective choices on the basis of various evaluation criteria established for evaluation, to thereby visualize how the AI reaches a final decision in an evaluation process.

### CITATION LIST

### Patent Literature

[PTL 1]
   JP 2020-126618A

### SUMMARY

### Technical Problem

However, an explanation regarding AI processing is generally directed to experts in this field and is often difficult to understand for persons other than these experts.

The present technology has been developed in consideration of the abovementioned circumstances, and the object thereof is to facilitate the understanding of an explanation regarding AI processing.

### Solution to Problem

An information processing system according to one aspect of the present technology includes an evaluation portion that evaluates multiple choices according to two or more evaluation criteria based on parameters obtained during a process or a result of machine learning, and an explanation portion that generates explanatory text regarding each of the choices by using a phrase associated with a corresponding one of the evaluation criteria.

An information processing method according to one aspect of the present technology is performed by an information processing system. The information processing method includes evaluating multiple choices according to two or more evaluation criteria based on parameters obtained during a process or a result of machine learning, and generating explanatory text regarding each of the choices by using a phrase associated with a corresponding one of the evaluation criteria.

A program according to one aspect of the present technology is a program for causing a computer to execute a process including steps of evaluating multiple choices according to two or more evaluation criteria based on parameters obtained during a process or a result of machine learning, and generating explanatory text regarding each of the choices by using a phrase associated with a corresponding one of the evaluation criteria.

According to the one aspect of the present technology, multiple choices are evaluated according to two or more evaluation criteria based on parameters obtained during a process or a result of machine learning, and explanatory text regarding each of the choices is generated by using a phrase associated with a corresponding one of the evaluation criteria.

### BRIEF DESCRIPTION OF DRAWINGS

FIG. 1 depicts diagrams for explaining an outline of the present technology.

FIG. 2 is a block diagram depicting a configuration example of an information processing system to which the present technology is applied.

FIG. 3 is a block diagram depicting a configuration example of a server.

FIG. 4 is a flowchart for explaining AI processing according to a first embodiment.

FIG. 5 is a flowchart for explaining the details of a selection process.

FIG. 6 is a diagram depicting an outline of evaluation of choices and creation of explanatory text.

FIG. 7 is a diagram depicting a correlation between evaluation criteria and modal auxiliaries.

FIG. 8 is a diagram depicting an example of a coordinate space of the evaluation criteria.

FIG. 9 is a diagram depicting an example of templates of explanatory text.

FIG. 10 is a diagram depicting a specific example of explanatory text.

FIG. 11 is a diagram depicting a specific example of explanatory text.

FIG. 12 is a diagram depicting a specific example of explanatory text.

FIG. 13 is a diagram depicting a specific example of explanatory text.

FIG. 14 is a flowchart for explaining AI processing according to a second embodiment.

### DESCRIPTION OF EMBODIMENTS

Modes for carrying out the present technology will hereinafter be described. The description will be presented in the following order.
1. Outline of present technology
2. Embodiments
3. Application examples
4. Modifications
5. Others

### 1. Outline of Present Technology

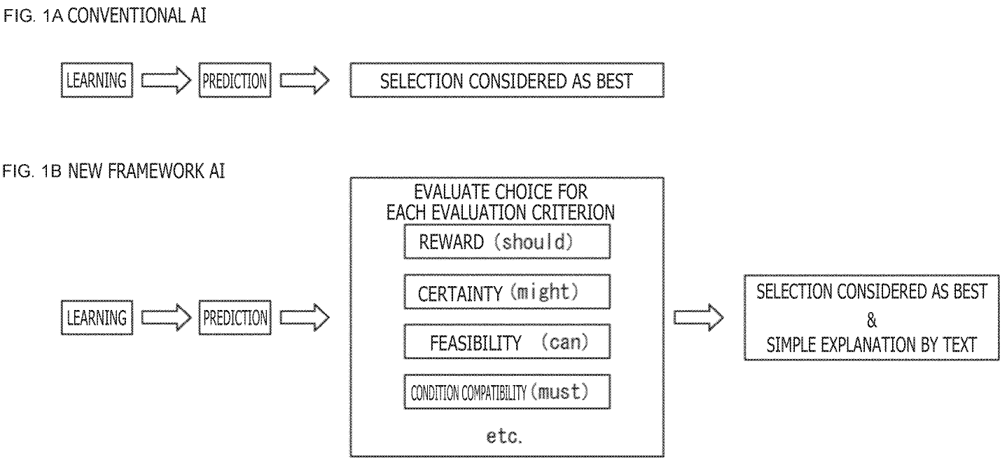

An outline of the present technology will first be described with reference to FIG. 1.

A of FIG. 1 illustrates a rough flow of processing by conventional AI.

For example, various predictions are made on multiple choices on the basis of a learning result obtained by machine learning or the like. Thereafter, the choice considered as the best is selected as final output from among the choices on the basis of the prediction result, and presented to a user.

B of FIG. 1 illustrates a rough flow of processing by AI with a new framework to which the present technology is applied.

For example, similarly to the processing in A of FIG. 1, various predictions are made on multiple choices on the basis of a learning result obtained by machine learning or the like.

Subsequently, the respective choices are evaluated for each of predetermined evaluation criteria on the basis of the prediction result. For example, the evaluation criteria are defined on the basis of parameters obtained during a process or as a result of machine learning, and assumed to include reward, certainty, feasibility, condition compatibility, and the like.

For example, the reward herein represents reward obtained by selecting the respective choices or executing methods indicated by the respective choices. For example, a reward amount (Reward) of reinforcement learning is adopted as the reward. For example, the reward amount of reinforcement learning is predictable by using a framework of reinforcement learning. However, the reward is not limited to the reward amount of reinforcement learning. For example, a reward amount calculated on the basis of coincidence with a result expected in supervised learning can be adopted as the reward.

For example, the certainty represents a probability that the reward described above will be obtained. For example, the feasibility represents a probability that a method indicated by each of the choices is feasible. For example, the condition compatibility represents a degree of compatibility between each of the choices and required and prohibited conditions.

In addition, the choice considered as the best is selected as final output from among the choices on the basis of an evaluation given for each of the evaluation criteria, and presented to the user.

Moreover, a simple explanation regarding AI processing (e.g., a result of selection from among the respective choices) is presented to the user in a form of text. This explanation uses phrases (words or phrases) corresponding to the respective evaluation criteria. For example, modal auxiliaries to be used include “should” for reward, “might” for certainty, “can” for feasibility, and “must” for condition compatibility.

For example, in a case of selecting an action, a human considers not only an action finally selected, but also other choices and possibilities. For example, to reach a destination, a human considers not only a choice of taking a taxi, but also other choices such as taking a train, driving an own car, and asking a friend to drive. This manner of selection by a human while considering other choices and possibilities is called modal cognition.

Moreover, for example, in a case of explaining an evaluation or a reason for selecting a choice, a human often uses modal auxiliaries such as “should,” “might,” “can,” and “must.”

In this case, an explanation regarding AI processing can be presented under a concept close to human modal cognition by using modal auxiliaries such as “should,” “might,” “can,” and “must” to explain the respective choices. Presentation of the explanation is thus achievable in a manner easy to understand even for persons other than experts.

### 2. Embodiments

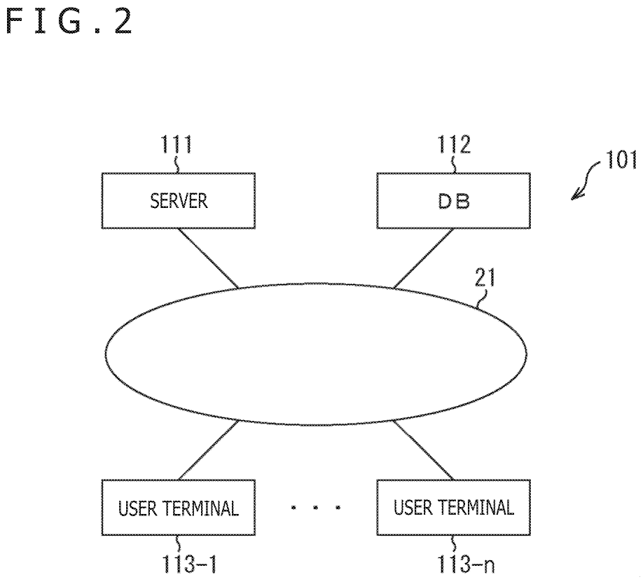

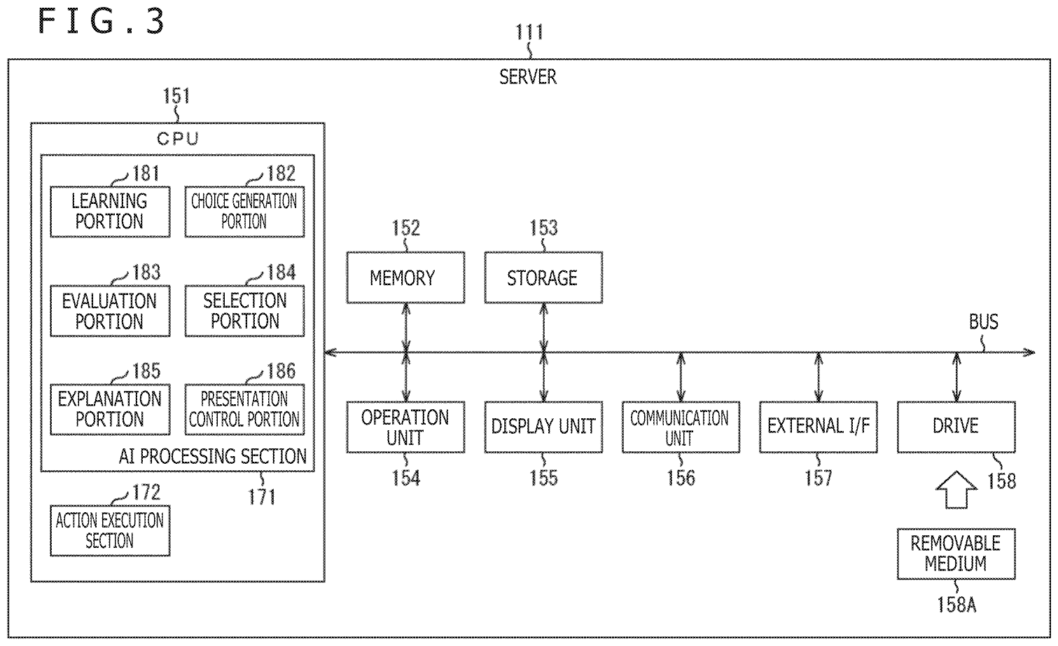

Next, embodiments of the present technology will be described with reference to FIGS. 2 to 14.

### Configuration Example of Information Processing System

FIG. 2 depicts a configuration example of an information processing system 1 to which the present technology is applied.

The information processing system 1 is a system that, with the use of AI, presents a user with a method for achieving a purpose set by the user (e.g., action), and that achieves the purpose set by the user.

The information processing system 1 includes a server 111, a DB (Database) 112, and user terminals 113-1 to 113-n. The server 111, the DB 112, and the user terminals 113-1 to 113-n are connected to one another via a network 121.

Note that, in a case where the user terminals 113-1 to 113-n do not need to be distinguished from one another, they will simply be referred to as user terminals 113 below.

The server 111 provides, with the use of AI, a method for achieving a purpose set by the user or a service presenting a result of execution of this method (hereinafter referred to as an AI service). For example, the server 111 performs, with the use of AI, a process for examining the method for achieving the purpose set by the user, on the basis of input information received from the user terminals 113 and information accumulated in the DB 112. Thereafter, the server 111 generates output information including a result of AI processing and an explanation regarding AI processing, and transmits the output information to the user terminals 113 via the network 121.

The DB 112 stores information necessary for AI processing performed by the server 111.

For example, the DB 112 stores rule information indicating a rule (e.g., law) for setting a required condition and a prohibited condition for achieving the purpose set by the user.

For example, the DB 112 stores case example information indicating a case example previously processed by the server 111, a case example previously caused, and the like. For example, the case example information includes information regarding a subject of a case example, the details of an action performed by the subject, a result of the action (e.g., the details of reward obtained by the action), an environment when the case example is caused, and the like.

For example, each of the user terminals 113 includes an information processing terminal such as a PC (Personal Computer), a smartphone, and a tablet terminal, and is operated by a user using an AI service. For example, each of the user terminals 113 generates input information necessary for using an AI service provided by the server 111, and transmits the input information to the server 111 via the network 121.

For example, the input information includes purpose information, subject information, and environment information.

For example, the purpose information includes information regarding a purpose desired to be achieved by the user. For example, the information regarding the purpose includes the type of reward desired by the user, a target value, and the like.

For example, the subject information includes information regarding a subject of the purpose indicated by the purpose information. For example, the subject of the purpose is a subject which executes a method for achieving the purpose, a subject which obtains reward by achieving the purpose, or the like. Moreover, for example, the information regarding the subject includes information regarding an attribute, a feature, and an ability of the subject, a resource available for the subject, and the like.

Note that the type of subject is not limited to a particular type. For example, a creature including a human, a plant, any one of various types of objects, a country, a corporation, any one of various types of groups, and the like are assumed to constitute the subject. Moreover, multiple subjects may be present.

For example, the environment information includes information regarding an environment when the subject executes a method for achieving the purpose. For example, the environment information includes sensor data acquired by sensors included in the user terminals 113. For example, the sensor data includes data indicating weather, temperature, position information, or the like.

Note that, in a case where the server 111 executes a method for achieving the purpose, for example, a sensor included in the server 111 may collect environment information such as sensor data.

The user terminals 113 receive, via the network 121, output information generated by the server 111 according to input information. The user terminals 113 present a result of AI processing and an explanation regarding AI processing to the user on the basis of the output information.

### Configuration Example of Server 111

FIG. 2 is a block diagram depicting a functional configuration example of the server 111 in FIG. 1.

The server 111 includes a CPU (Central Processing Unit) 151, a memory 152, a storage 153, an operation unit 154, a display unit 155, a communication unit 156, an external I/F (Interface) 157, and a drive 158. The CPU 151 to the drive 158 are connected to a bus to communicate with one another as necessary.

The CPU 151 executes a program installed in the memory 152 or the storage 153, to perform various processes.

For example, the memory 152 includes a volatile memory or the like, and temporarily stores the program to be executed by the CPU 151 or necessary data.

For example, the storage 153 includes a hard disk or a non-volatile memory, and stores the program to be executed by the CPU 151 or necessary data.

The operation unit 154 includes physical keys (including a keyboard), a mouse, a touch panel, and the like. The operation unit 154 outputs an operation signal corresponding to an operation performed by the user, to the bus according to this operation.

For example, the display unit 155 includes an LCD (Liquid Crystal Display) and the like, and displays an image according to data supplied from the bus.

The communication unit 156 includes a communication circuit, an antenna, and the like, and communicates with the DB 112 and the user terminals 113 via the network 121.

The external I/F 157 is an interface for data exchange with various external devices.

For example, the drive 158 is a drive to which a removable medium 158A such as a memory card is detachably attached, and drives the removable medium 158A attached to the drive 158.

In the server 111 configured as above, the program to be executed by the CPU 151 can be recorded beforehand in the storage 153 which is a recording medium built in the CPU 151.

Alternatively, the program can be stored (recorded) in the removable medium 158A and provided in a form of what is called package software, and can be installed from the removable medium 158A into the server 111.

Instead, the program can be downloaded from a different server or the like, which is not depicted, via the network 121 and the communication unit 156, and installed into the server 111.

The CPU 151 executes the program installed in the server 111, to implement an AI processing section 171 and a communication control section 172.

The AI processing section 171 performs processing using AI. The AI processing section 171 includes a learning portion 181, a choice generation portion 182, an evaluation portion 183, a selection portion 184, an explanation portion 185, and a presentation control portion 186.

The learning portion 181 performs a learning process such as machine learning necessary for AI processing. For example, the learning portion 181 performs reinforcement learning on the basis of case example information stored in the DB 112, to generate an evaluation function to be used by the evaluation portion 183.

The choice generation portion 182 generates choices each associated with a method for achieving a purpose indicated by input information, on the basis of input information received from the user terminals 113 and information stored in the DB 112.

The evaluation portion 183 evaluates the respective generated choices on the basis of multiple evaluation criteria.

The selection portion 184 selects output to be presented to the user, on the basis of evaluations given for the respective choices according to the respective evaluation criteria.

The explanation portion 185 executes a process for presenting an explanation regarding AI processing performed by the AI processing section 171. For example, the explanation portion 185 generates explanatory text regarding AI processing, on the basis of input information received from the user terminals 113, an evaluation result obtained by the evaluation portion 183 for the respective choices, an output selection result obtained by the selection portion 184, or the like.

The presentation control portion 186 controls the presentation of an AI processing result obtained by the user terminals 113 and an explanation regarding AI processing.

For example, the presentation control portion 186 generates output information including a result of AI processing and an explanation regarding AI processing. For example, the result of AI processing includes information regarding output selected by the selection portion 184, a result of execution of a process according to the selected output, or the like. For example, the explanation regarding AI processing includes explanatory text generated by the explanation portion 185.

The presentation control portion 186 transmits output information to the user terminals 113 via the communication unit 156 and the network 121 to cause the user terminals 113 to present the result of AI processing and the explanation regarding AI processing to the user terminals.

The communication control section 172 controls the communication by the communication unit 156.

Note that the description of “via the communication unit 156 and the network 121” will hereinafter be omitted even in a case where each of the components of the server 111 communicates with the DB 112 and the user terminals 113 via the communication unit 156 and the network 121. For example, in a case where the presentation control portion 186 communicates with the user terminals 113 via the communication unit 156 and the network 121, this situation will simply be described as “the presentation control portion 186 communicates with the user terminals 113.”

### First Embodiment of AI Processing

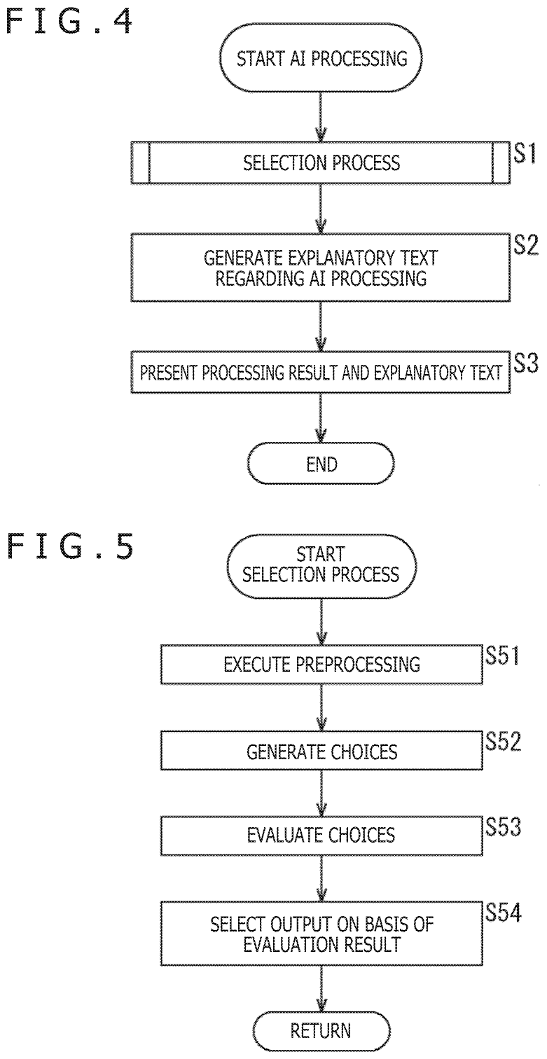

Next, AI processing executed by the server 111 will be described with reference to a flowchart in FIG. 4.

For example, this processing is started when the CPU 151 of the server 111 receives input information from any one of the user terminals 113. As described above, the input information includes purpose information, subject information, and environment information, for example.

In step S1, the server 111 executes a selection process.

The details of the selection process will be described herein with reference to a flowchart in FIG. 5.

In step S51, the server 111 executes preprocessing. Specifically, the communication unit 156 supplies input information received from the user terminal 113 to the CPU 151.

The choice generation portion 182 extracts a subject and a purpose set by the user, on the basis of subject information and purpose information included in the input information. For example, the choice generation portion 182 extracts case example information regarding a previous case example having a subject and a purpose similar to the subject and the purpose set by the user, from information stored in the DB 112 as case example information.

In step S52, the choice generation portion 182 generates choices. For example, the choice generation portion 182 examines methods that are likely to achieve the purpose set by the user, on the basis of the previous case example or the like extracted in the process in step S51. The choice generation portion 182 generates multiple choices indicating multiple methods obtained as a result of the examination.

Note that the choice generation portion 182 may generate the choices without excessively considering whether or not the purpose is actually achievable and feasible, for example. Moreover, for example, the choice generation portion 182 may evaluate the choices by using an evaluation function which gives more lenient evaluation than an evaluation function (described later) generated by the learning portion 181, and decrease the number of the choices on the basis of a result of this evaluation.

Note that the user may create a choice and add the created choice to the input information, for example. In this case, the choice generation portion 182 adds the choice set by the user, to the generated choices.

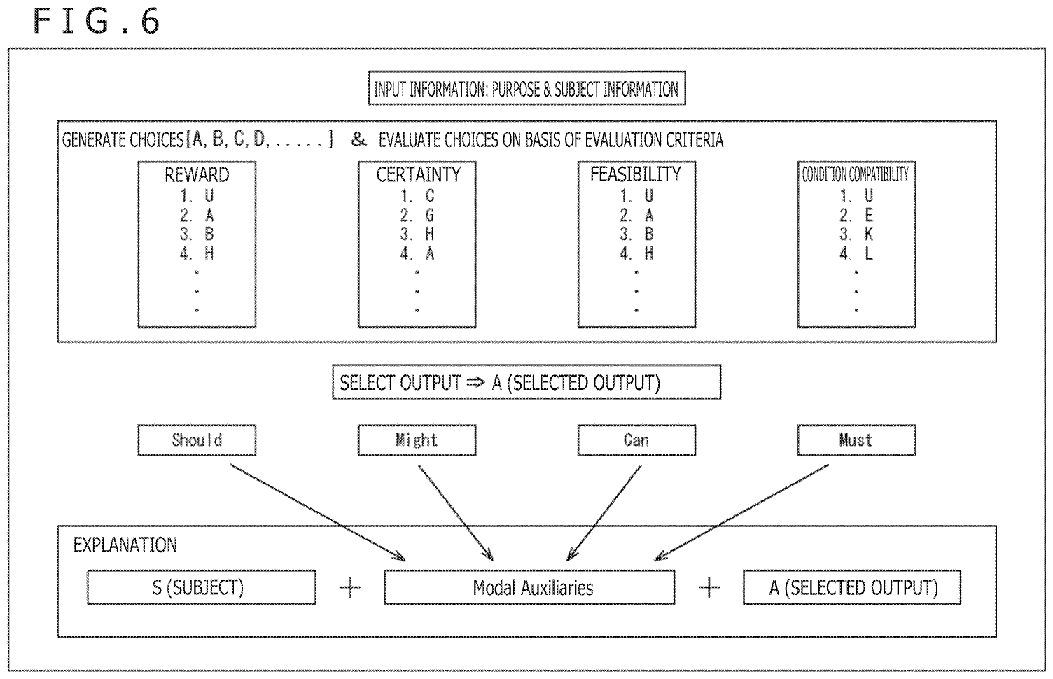

This process generates choices A, B, C, D, and others depicted in FIG. 6, for example.

In step S53, the server 111 evaluates the respective choices.

For example, the learning portion 181 performs reinforcement learning on the basis of a previous similar case example to generate an evaluation function which achieves evaluation on the basis of three types of evaluation criteria, i.e., reward, certainty, and feasibility, for each.

For example, the learning portion 181 generates an evaluation function for predicting reward that is obtained by executing each of methods corresponding to the respective choices, on the basis of the respective choices, an environment when the methods corresponding to the respective choices are executed, and the like.

For example, the learning portion 181 generates an evaluation function for predicting a probability that reward will be obtained by executing each of the methods corresponding to the respective choices, on the basis of the respective choices, the environment when the methods corresponding to the respective choices are executed, and the like.

For example, the learning portion 181 generates an evaluation function for predicting a probability that the methods corresponding to the respective choices are feasible, on the basis of an ability of the subject, a resource available for the subject, the environment when the methods corresponding to the respective choices are executed, and the like.

The evaluation portion 183 evaluates reward, certainty, and feasibility for each of the choices by using the generated evaluation functions. In this manner, the evaluation portion 183 predicts evaluation values of reward, certainty, and feasibility for each of the choices.

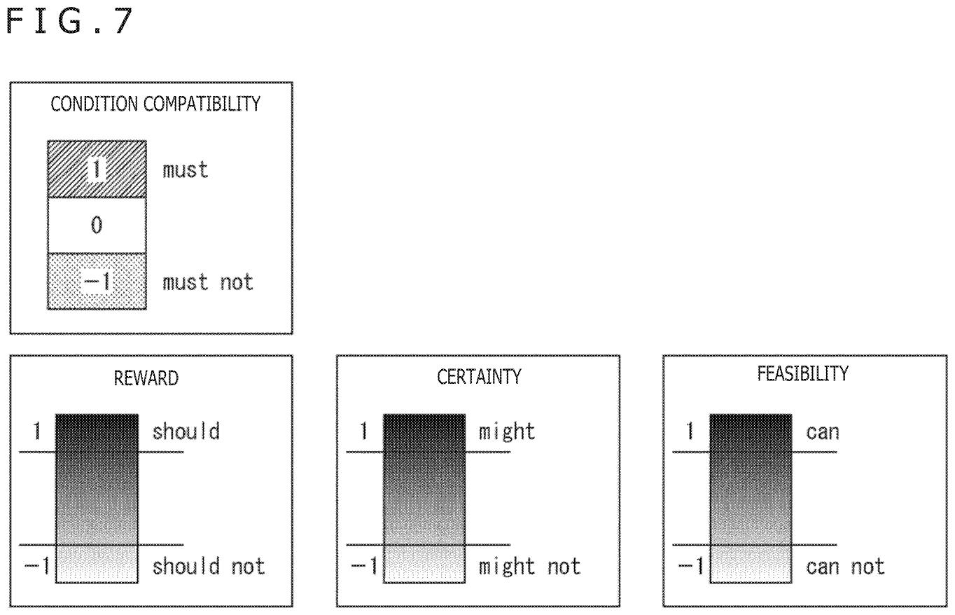

Moreover, as depicted in FIG. 7, the evaluation portion 183 normalizes the evaluation values of reward, certainty, and feasibility of the respective choices to values within a range of −1 to 1. In this case, each of the evaluation values approaches 1 as the corresponding evaluation of reward, certainty, and feasibility increases. On the other hand, each of the evaluation values approaches −1 as the corresponding evaluation of reward, certainty, and feasibility decreases.

Further, the evaluation portion 183 extracts a rule indicating a required matter and a prohibited matter for achieving the purpose, from rule information stored in the DB 112, on the basis of the set subject and purpose. The evaluation portion 183 sets a required condition indicating the required matter and a prohibited condition indicating the prohibited matter, on the basis of the extracted rule. Note that the evaluation portion 183 does not set the required condition and the prohibited condition in a case where the rule indicating the required matter and the prohibited matter for achieving the purpose is absent.

For example, in a case where the server 111 executes route planning, a transit point required to be transited is set as the required condition, for example, and an entry-prohibited zone is set as the prohibited condition, for example.

Thereafter, for example, the evaluation portion 183 sets an evaluation value of condition compatibility to any one of 1, 0, and −1 for each of the choices on the basis of the required condition and the prohibited condition as depicted in FIG. 7. Specifically, in a case where the prohibited condition is present, the evaluation portion 183 sets the evaluation value of condition compatibility to −1 for the choice meeting the prohibited condition. Moreover, in a case where the required condition is present, the evaluation portion 183 sets the evaluation value of condition compatibility to 1 for the choice meeting the required condition among the choices not meeting the prohibited condition. Further, the evaluation portion 183 sets the evaluation value of condition compatibility to 0 for the choice meeting neither the required condition nor the prohibited condition. Note that, in a case where both the required condition and the prohibited condition are absent, the evaluation portion 183 sets the evaluation value of condition compatibility to 0 for all the choices.

Note that the evaluation portion 183 may rank the respective choices for each of the evaluation items as necessary as depicted in FIG. 6, for example.

In step S54, the selection portion 184 selects output on the basis of an evaluation result.

First, the selection portion 184 selects output while considering condition compatibility as priority. For example, in a case where only one choice having the evaluation value of 1 is present, i.e., only one choice meeting the required condition and not meeting the prohibited condition is present, the selection portion 184 selects this choice as output.

On the other hand, in a case where two or more choices each having the evaluation value of 1 for condition compatibility are present, i.e., two or more choices each meeting the required condition and not meeting the prohibited condition are present, the selection portion 184 extracts these choices. Thereafter, the selection portion 184 calculates a sum of the evaluation values of reward, certainty, and feasibility as an overall evaluation value for each of the extracted choices. At this time, the selection portion 184 may weight each of the evaluation values of reward, certainty, and feasibility to achieve weighted addition. In this case, a weight for reward is set to the largest value, for example. Thereafter, the selection portion 184 selects the choice having the largest overall evaluation value, as output.

On the other hand, in a case where the choice having the evaluation value of 1 for condition compatibility is absent, the selection portion 184 extracts the choices each not having the evaluation value of −1 for condition compatibility, i.e., the choices not meeting the prohibited condition, from all the choices. In this manner, the choices meeting the prohibited condition are excluded. Thereafter, the selection portion 184 calculates the overall evaluation value for each of the choices by the method described above, and selects the choice having the largest overall evaluation value, as output.

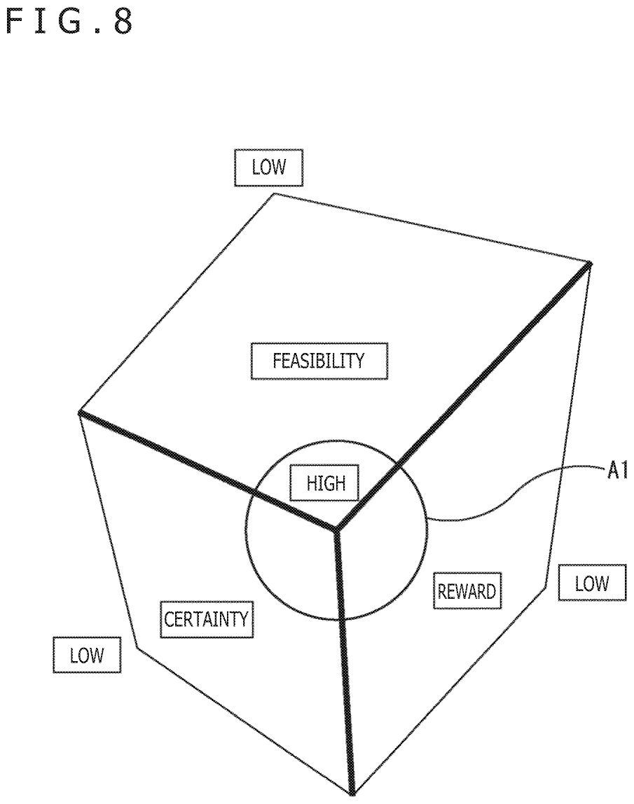

FIG. 8 depicts a coordinate system having three axes of reward, certainty, and feasibility. For example, in a case where the respective choices are disposed on the coordinate system depicted in FIG. 8 on the basis of the respective evaluation values of reward, certainty, and feasibility, the choices falling within a region A1 are each selected as output. In other words, the choices each having high evaluation values of reward, certainty, and feasibility are each selected as output.

Thereafter, the selection process ends.

Described with reference to FIG. 4 again, the explanation portion 185 generates explanatory text regarding the AI processing in step S2.

For example, as depicted in FIG. 6, the explanation portion 185 generates explanatory text regarding output, by combining a subject (S), any one of modal auxiliaries “should,” “might,” “can,” and “must,” and selected output (A).

Moreover, the explanation portion 185 generates explanatory text regarding the choices other than the selected output, i.e., the choices not selected, if necessary. In this case, each of the choices not selected is inserted into a part corresponding to A of the explanatory text.

For example, the explanation portion 185 selects the modal auxiliary to be inserted into the explanatory text for each of the choices, on the basis of evaluation values of the respective criteria for the respective choices, and sets a use method of the selected modal auxiliary as depicted in FIG. 7. For example, the use method of the modal auxiliary includes the use or disuse of the modal auxiliary and selection of an affirmative form or a negative form.

For example, the explanation portion 185 selects “must” as the modal auxiliary corresponding to condition compatibility, in a case where the value of condition compatibility is +1. For example, the explanation portion 185 selects “must not” as the modal auxiliary corresponding to condition compatibility, in a case where the value of condition compatibility is −1. For example, the explanation portion 185 does not use any modal auxiliary corresponding to condition compatibility, in a case where the value of condition compatibility is 0.

For example, the explanation portion 185 selects “should” as the modal auxiliary corresponding to reward, in a case where the evaluation value of reward is a first threshold or larger, i.e., the evaluation value of reward is close to 1. For example, the explanation portion 185 selects “should not” as the modal auxiliary corresponding to reward, in a case where the evaluation value of reward is a second threshold or smaller, i.e., the evaluation value of reward is close to −1. For example, the explanation portion 185 does not use any modal auxiliary corresponding to reward, in a case where the evaluation value of reward is larger than the second threshold but smaller than the first threshold.

For example, the explanation portion 185 selects “might” as the modal auxiliary corresponding to certainty, in a case where the evaluation value of certainty is a first threshold or larger, i.e., the evaluation value of certainty is close to 1. For example, the explanation portion 185 selects “might not” as the modal auxiliary corresponding to certainty, in a case where the evaluation value of certainty is a second threshold or smaller, i.e., the evaluation value of certainty is close to −1. For example, the explanation portion 185 does not use any modal auxiliary corresponding to certainty, in a case where the evaluation value of certainty is larger than the second threshold but smaller than the first threshold.

For example, the explanation portion 185 selects “can” as the modal auxiliary corresponding to feasibility, in a case where the evaluation value of feasibility is a first threshold or larger, i.e., the evaluation value of feasibility is close to 1. For example, the explanation portion 185 selects “can not” as the modal auxiliary corresponding to feasibility, in a case where the evaluation value of feasibility is a second threshold or smaller, i.e., the evaluation value of feasibility is close to −1. For example, the explanation portion 185 does not use any modal auxiliary corresponding to feasibility, in a case where the evaluation value of feasibility is larger than the second threshold but smaller than the first threshold.

As described above, each of reward, certainty, and feasibility is classified into three levels, and the use of the affirmative form of the corresponding modal auxiliary, the disuse of the modal auxiliary, or the use of the negative form of the auxiliary is selected according to each level.

Note herein that, in a case where a human thinks something, human recognition is often limited by a language to be used. For example, a human in most cases consciously classifies feasibility into three categories (possible, impossible, unknown) even while his or her head is processing feasibility in a probabilistic manner. Accordingly, a possibility that the user feels uncomfortable is low even when the modal auxiliary to be used is changed for each of the three levels classified for each of reward, certainty, and feasibility as described above.

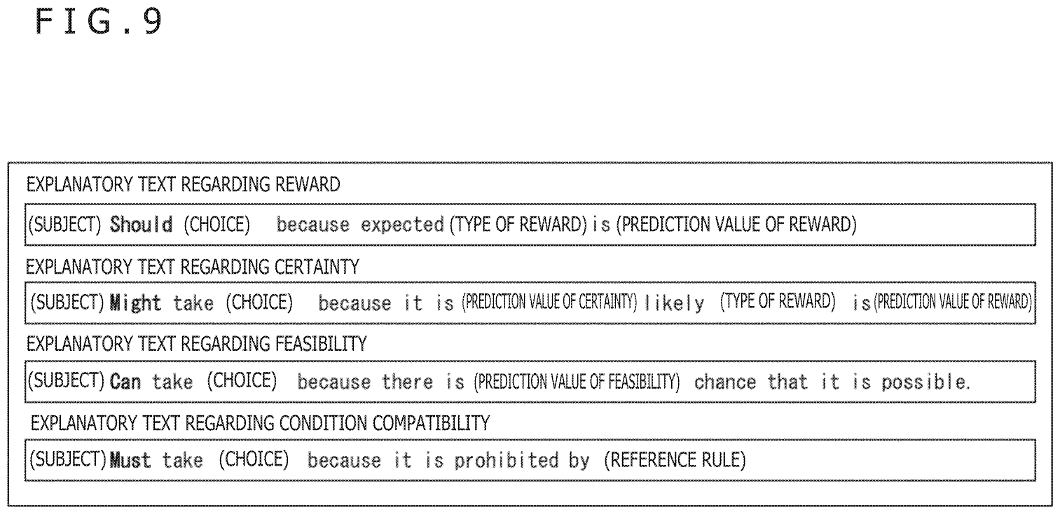

Next, the explanation portion 185 generates explanatory text regarding the respective choices, by using the selected modal auxiliaries, for each of the evaluation criteria. At this time, the explanation portion 185 uses templates determined according to a rule base as depicted in FIG. 9, for example.

For example, explanatory text regarding reward is generated by using the following template.

(Subject) Should (Choice) Because Expected (Type of Reward) is (Prediction Value of Reward).

For example, a phrase representing a subject set on the basis of subject information is inserted into the part (subject). For example, a phrase representing a choice corresponding to a target for which the explanatory text is generated is inserted into the part (choice). For example, a phrase representing the type of reward is inserted into the part (type of reward). For example, a phrase representing an evaluation value of reward for the choice is inserted into the part (prediction value of reward).

Presented by using this template is a prediction value of reward expected to be obtained in a case of selection of the choice corresponding to the target of the explanatory text.

For example, explanatory text regarding certainty is generated by using the following template.

(Subject) Might Take (Choice) Because it is (Prediction Value of Certainty) Likely (Type of Reward) is (Prediction Value of Reward).

For example, a phrase representing a subject set on the basis of subject information is inserted into the part (subject). For example, a phrase representing a choice corresponding to a target for which the explanatory text is generated is inserted into the part (choice). For example, a phrase representing an evaluation value of certainty for the choice is inserted into the part (prediction value of certainty). For example, a phrase representing the type of reward is inserted into the part (type of reward). For example, a phrase representing an evaluation value of reward for the choice is inserted into the part (prediction value of reward).

Presented by using this template is a predicted value of certainty that the predicted reward will be obtained in a case of selection of the choice corresponding to the target of the explanatory text.

For example, explanatory text regarding feasibility is generated by using the following template.

(Subject) Can Take (Choice) Because there is (Prediction Value of Feasibility) Chance that it is Possible.

For example, a phrase representing a subject set on the basis of subject information is inserted into the part (subject). For example, a phrase representing a choice corresponding to a target for which the explanatory text is generated is inserted into the part (choice). For example, a phrase representing an evaluation value of feasibility for the choice is inserted into the part (prediction value of feasibility).

Presented by using this template is a possibility that the choice corresponding to the target of the explanatory text is feasible.

For example, explanatory text regarding condition compatibility is generated by using the following template.

(Subject) Must Take (Choice) Because it is Prohibited by (Reference Rule).

For example, a phrase representing a subject set on the basis of subject information is inserted into the part (subject). For example, a phrase representing a choice corresponding to a target for which the explanatory text is generated is inserted into the part (choice). For example, a phrase representing a rule such as a law referred to for setting a required condition or a prohibited condition is inserted into the part (reference rule).

Presented by using this template is a reason for the necessity of selection of the choice corresponding to the target of the explanatory text, or a reason for prohibition of this selection.

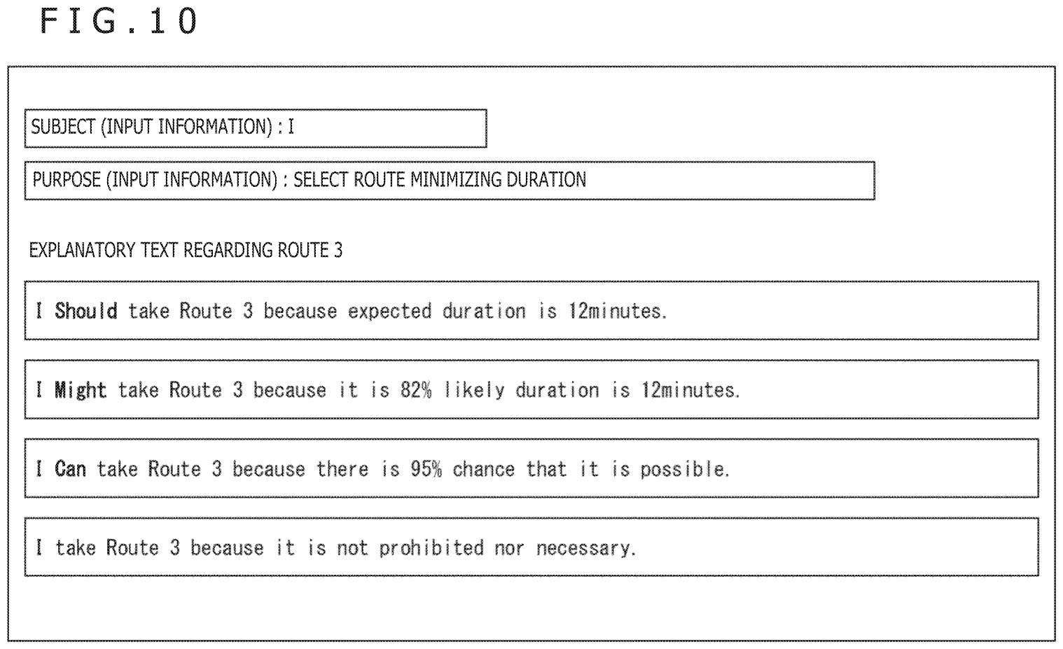

FIGS. 10 to 13 each depict a specific example of explanatory text.

Specifically, in each of the text examples of FIGS. 10 to 12, the subject is “I,” and the purpose is to “select a route for minimizing duration.”

In this case, reward corresponds to duration, and reward increases as duration decreases.

FIG. 10 depicts an example of explanatory text regarding Route 3 selected as output.

The following text is generated as explanatory text regarding reward, for example.

I Should take Route 3 because expected duration is 12 minutes.

In this explanatory text, it is presented that I (subject) should select Route 3 because predicted duration (reward) continues for 12 minutes, for example.

The following text is generated as explanatory text regarding certainty, for example.

I Might take Route 3 because it is 82% likely duration is 12 minutes.

In this explanatory text, it is presented that I (subject) may select Route 3 because a probability that duration (reward) continues for 12 minutes is 82%, for example.

The following text is generated as explanatory text regarding feasibility, for example.

I Can take Route 3 because it is 95% chance that it is possible.

In this explanatory text, it is presented that I (subject) can select Route 3 because feasibility (e.g., a possibility of reaching a destination via Route 3) is 95%, for example.

The following text is generated as explanatory text regarding condition compatibility, for example.

I take Route 3 because it is not prohibited nor necessary.

In this explanatory text, it is presented that selection of Route 3 is not prohibited nor necessary, for example.

For example, the user can easily understand a reason or a basis for selection of Route 3 on the basis of the above explanatory text presented to the user. For example, the user recognizes that Route 3 has been selected because of short duration, high certainty of duration and feasibility of Route 3, and no particular prohibition. As a result, for the user, reliability and satisfaction of the result of the AI processing are improved, for example.

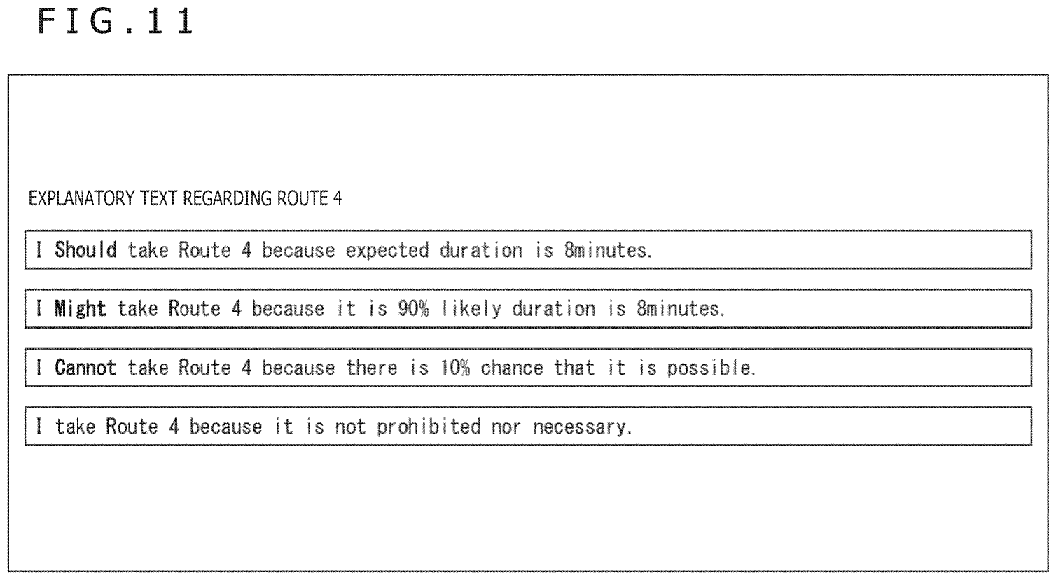

FIG. 11 depicts an example of explanatory text regarding Route 4 not selected.

The following text is generated as explanatory text regarding reward, for example.

I Should take Route 4 because expected duration is 8 minutes.

In this explanatory text, it is presented that I (subject) should select Route 4 because predicted duration (reward) continues for 8 minutes, for example.

The following text is generated as explanatory text regarding certainty, for example.

I Might take Route 4 because it is 90% likely duration is 8 minutes.

In this explanatory text, it is presented that I (subject) may select Route 4 because a probability that duration (reward) continues for 8 minutes is 90%, for example.

The following text is generated as explanatory text regarding feasibility, for example.

I Cannot take Route 4 because it is 10% chance that it is possible.

In this explanatory text, it is presented that I (subject) cannot select Route 4 because feasibility (e.g., a possibility of reaching the destination via Route 4) is 10%, for example.

The following text is generated as explanatory text regarding condition compatibility, for example.

I take Route 4 because it is not prohibited nor necessary.

In this text, it is presented that selection of Route 4 is not prohibited nor necessary, for example.

For example, the user can easily understand a reason or a basis why Route 4 has not been selected, on the basis of the above explanatory text presented to the user. For example, the user recognizes that Route 4 has not been selected because a possibility of reaching the destination is as low as 10% even though duration is shorter than that of Route 3. As a result, for the user, reliability and satisfaction of the result of the AI processing are improved, for example.

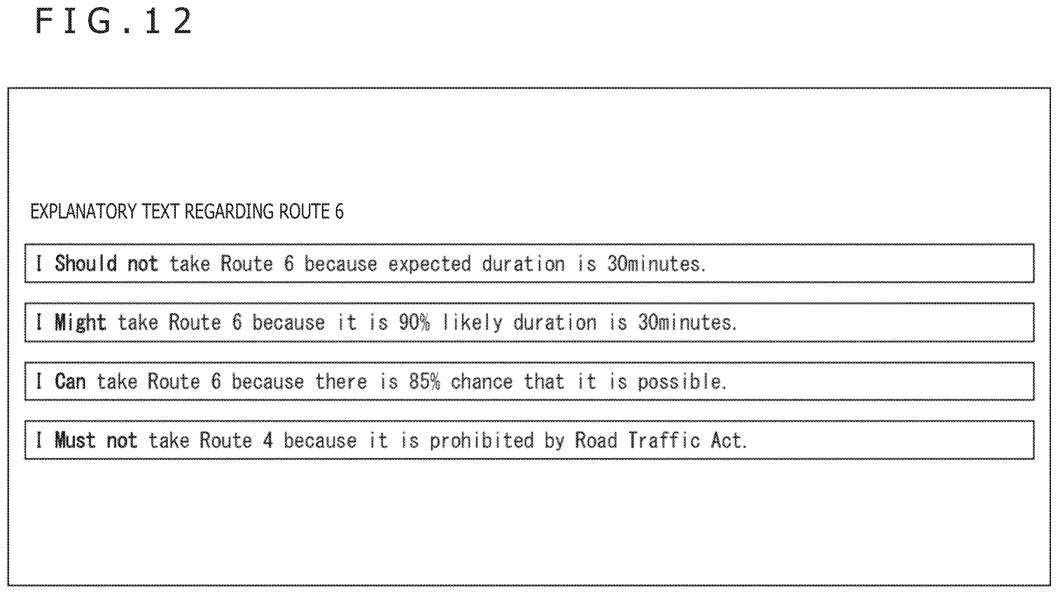

FIG. 12 depicts an example of explanatory text regarding Route 6 not selected.

The following text is generated as explanatory text regarding reward, for example.

I Should not take Route 6 because expected duration is 30 minutes.

In this explanatory text, it is presented that I (subject) should not select Route 6 because predicted duration (reward) continues for 30 minutes, for example.

The following text is generated as explanatory text regarding certainty, for example.

I Might take Route 6 because it is 90% likely duration is 30 minutes.

In this explanatory text, it is presented that I (subject) may select Route 6 because a probability that duration (reward) continues for 30 minutes is 90%, for example.

The following text is generated as explanatory text regarding feasibility, for example.

I Can take Route 6 because it is 85% chance that it is possible.

In this explanatory text, it is presented that I (subject) can select Route 6 because feasibility (e.g., a possibility of reaching the destination via Route 6) is 85%, for example.

The following text is generated as explanatory text regarding condition compatibility, for example.

I Must not take Route 6 because it is not prohibited by Road Traffic Act.

In this explanatory text, it is presented that I (subject) must not select Route 6 because Route 6 is prohibited by Road Traffic Act, for example.

For example, the user can easily understand a reason or a basis why Route 6 has not been selected, on the basis of the above explanatory text presented to the user. For example, the user recognizes that Route 6 has not been selected because Route 6 has long duration and is prohibited by Road Traffic Act. As a result, for the user, reliability and satisfaction of the result of the AI processing are improved, for example.

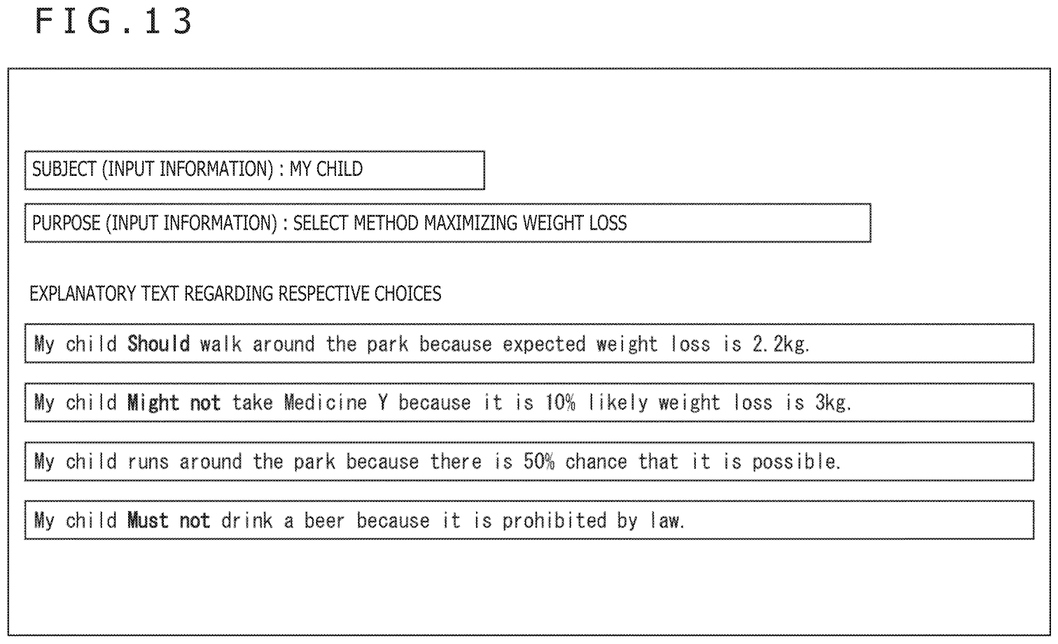

In the example of FIG. 13 presenting a case of selection of a method for losing weight, the subject is “my child,” and the purpose is to “select a method for maximizing a weight loss.”

In this case, reward corresponds to a weight loss, and reward increases as a weight loss increases.

FIG. 13 depicts an example of explanatory text regarding respective choices.

The following text is generated as explanatory text regarding reward, for example.

My child Should walk around the park because expected weight loss is 2.2 kg.

In this explanatory text, it is presented that my child (subject) should walk around the park because a predicted weight loss (reward) is 2.2 kg, for example.

The following text is generated as explanatory text regarding certainty, for example.

My child Might not take Medicine Y because it is 10% likely weight loss is 3 kg.

In this explanatory text, it is indicated that my child (subject) might not take Medicine Y because a probability of a weight loss of 3 kg is 10%, for example.

The following text is generated as explanatory text regarding feasibility, for example.

My child runs around the park because there is 50% chance that it is possible.

In this explanatory text, it is indicated that feasibility (e.g., a possibility that my child (subject) will run around the park) is 50%.

The following text is generated as explanatory text regarding condition compatibility, for example.

My child Must not drink a beer because it is prohibited by law.

In this explanatory text, it is indicated that my child (subject) should not drink beer because drinking beer is prohibited by a law.

The user is allowed to compare the respective choices from various viewpoints, for example, on the basis of the above explanatory text presented to the user.

Described with reference to FIG. 4 again, the server 111 presents the processing result and the explanatory text in step S3. For example, the presentation control portion 186 generates presentation data for presenting the result of AI processing and the explanation text regarding AI processing.

For example, the result of the AI processing includes information regarding an output selection result obtained by AI (e.g., the respective choices and information regarding output selected from among the respective choices). Moreover, for example, the result of the AI processing may include a result obtained by executing a method corresponding to the selected output (e.g., action) as necessary. For example, the explanation text regarding the AI processing includes explanation text regarding the respective evaluation criteria for the respective choices described above. The presentation control portion 186 transmits the presentation data to the user terminal 113.

The user terminal 113 presents the result of the AI processing and the explanation text on the basis of the presentation data.

At this time, for example, only the selected output may be presented, or the other choices may also be presented. Moreover, for example, the result obtained by executing the method corresponding to the selected output may be presented.

Further, for example, only the explanatory text regarding the selected output may be presented, or the explanatory text regarding the other choices may also be presented. In addition, for example, the explanatory text regarding all the evaluation criteria is not necessarily required to be presented, but only the explanatory text regarding some of the evaluation criteria may be presented.

Thereafter, the AI processing ends.

As described above, the explanation regarding the result of the AI processing is presented in a natural form of text. In this manner, the user is allowed to easily understand a reason or a basis for the result of the AI processing. As a result, for the user, reliability and satisfaction of the result of the AI processing are improved, for example. On the other hand, in a case where the user has a question about the result of the AI processing, for example, it is possible that the user can figure out what causes this question.

Moreover, the explanatory text is mechanically generated by using the predetermined template. Accordingly, a load imposed on generation of the explanatory text can be reduced.

### Second Embodiment of AI Processing

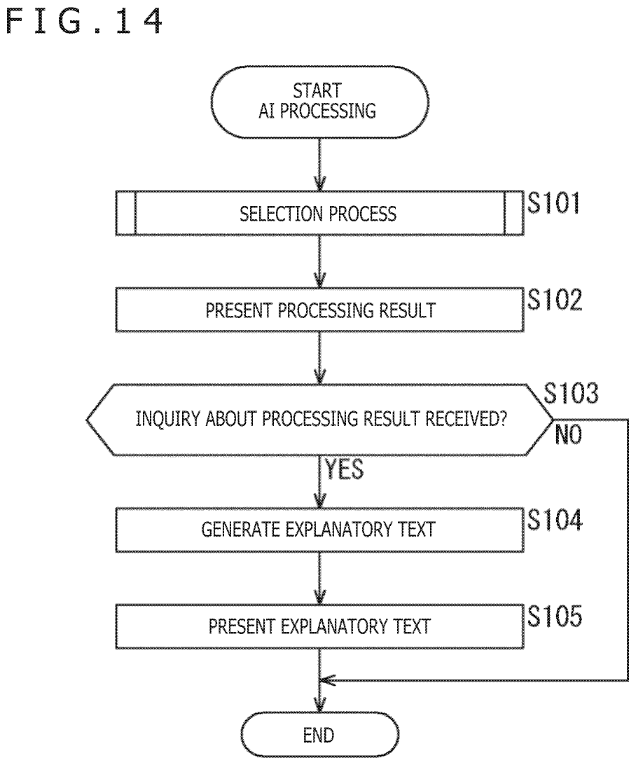

Next, AI processing executed by the server 111 according to a second embodiment will be described with reference to a flowchart in FIG. 14.

For example, this processing is started when the server 111 receives input information from any one of the user terminals 113, similarly to the first embodiment.

In step S101, the selection process is executed similarly to the process in step S1 in FIG. 4.

In step S102, the server 111 presents a processing result. For example, the presentation control portion 186 generates presentation data necessary for presenting a result of the AI processing, by a process similar to the process in step S3 described above with reference to FIG. 4. The presentation control portion 186 transmits the presentation data to the user terminal 113.

The user terminal 113 presents the result of the AI processing on the basis of the presentation data. At this time, explanatory text regarding the AI processing is not presented unlike the process in step S3 in FIG. 4.

In step S103, the presentation control portion 186 determines whether or not an inquiry about the processing result has been received.

For example, in a case where the user determines that an explanation regarding the presented result of the AI processing is necessary, the user performs an operation for requesting the explanation regarding the processing result, by using the user terminal 113. Specifically, in a case where the user desires to know a reason why AI has selected the output, a reason why AI has not selected the other choices, or the like, for example, the user performs an operation for requesting the explanation regarding the processing result, by using the user terminal 113. The user terminal 113 transmits a command requesting the explanation regarding the processing result to the server 111 via the network 121.

Thereafter, in a case of reception of this command from the user terminal 113, the presentation control portion 186 of the server 111 determines that an inquiry about the processing result has been received in step S103, and the process proceeds to step S104.

In step S104, explanation text is generated similarly to the process in step S2 in FIG. 4.

In step S105, the server 111 presents the explanatory text. For example, the presentation control portion 186 generates presentation data necessary for presenting the explanatory text regarding the AI processing, by a process similar to the process in step S3 described above with reference to FIG. 4. The presentation control portion 186 transmits the presentation data to the user terminal 113.

The user terminal 113 presents the explanatory text regarding the AI processing on the basis of the presentation data.

Thereafter, the AI processing ends.

On the other hand, in a case of determination that an inquiry about the processing result has not been received in step S103, the processes in step S104 and step S105 are omitted, and the AI processing ends.

In the manner described above, the user is allowed to receive the explanation regarding the result of the AI processing, as necessary.

Note that the user may designate contents of the presented explanation text, for example. For example, the user may designate choices or evaluation criteria for which explanatory text is to be presented, for example.

### 3. Application Examples

Next, application examples of the present technology will be described.

While described above has been the examples which apply the present technology to the server 111 performing processing with the use of AI in response to a request from the user terminals 113, the present technology is applicable to software and hardware using AI in general.

Described hereinbelow will be examples of a combination of choices, reward, certainty, feasibility, and condition compatibility, and others in respective application examples.

### Examples of Application to Software

For example, the present technology is applicable to software performing various processes by using AI in general.

### <Recognition Software>

For example, the present technology is applicable to recognition software in general. Specifically, for example, the present technology is applicable to recognition software for security. The following examples are adoptable as a combination of choices, reward, certainty, feasibility, and condition compatibility in this case.

### (Choice)

For example, multiple targets to be recognized correspond to choices, and any one of the targets corresponds to output (recognition target).

For example, recognition processes such as “recognizing a target” and “determining an action on the basis of a recognition result” correspond to choices, and any one of the processes corresponds to output.

### (Reward)

For example, reward is evaluated on the basis of an expectation value of acquisition of a necessary recognition result.

### (Certainty)

For example, certainty is evaluated on the basis of a probability that the above reward will be obtained.

For example, certainty is evaluated on the basis of a level of recognition accuracy expected to be guaranteed.

### (Feasibility)

For example, feasibility is evaluated on the basis of a resource available for a recognition process. Specifically, for example, feasibility is evaluated on the basis of whether or not a calculation time achieved by an available resource is realistic or the like.

For example, feasibility is evaluated on the basis of accessibility. For example, feasibility is evaluated on the basis of information necessary for the recognition process, whether or not learning data or the like is accessible, or the like.

For example, feasibility is evaluated on the basis of accuracy of knowledge. For example, feasibility is evaluated on the basis of whether or not knowledge of the user or the recognition target is sufficient, or the user or the recognition target is recognizable.

For example, a prohibited condition is set on the basis of viewpoints such as privacy, security, pornography, or an operation-prohibited area. Thereafter, condition compatibility is evaluated on the basis of the set prohibited condition.

### <Search Software>

For example, the present technology is applicable to search (e.g., image search, text search) software. The following examples are adoptable as a combination of choices, reward, certainty, feasibility, and condition compatibility in this case.

### (Choice)

In a case where multiple search results are present, for example, the respective search results correspond to choices, and a search result finally presented corresponds to output.

### (Reward)

For example, reward is evaluated on the basis of accuracy of respective search results.

### (Certainty)

For example, certainty is evaluated on the basis of satisfactory levels of respective search results for the user.

For example, certainty is evaluated on the basis of presence of other similar search results or the like obtained by inconsistencies of words or the like.

### (Feasibility)

For example, feasibility is evaluated on the basis of a resource available for a search process. For example, feasibility is evaluated on the basis of whether or not a calculation time achieved by an available resource is realistic or the like.

For example, feasibility is evaluated on the basis of accessibility. For example, feasibility is evaluated on the basis of information necessary for the search process, whether or not learning data or the like is accessible, or the like.

For example, feasibility is evaluated on the basis of accuracy of knowledge. For example, feasibility is evaluated on the basis of whether or not knowledge of the user or the search target is sufficient, or whether or not the user or the search target is searchable.

For example, a prohibited condition is set on the basis of viewpoints such as privacy, security, pornography, or an operation-prohibited area. Thereafter, condition compatibility is evaluated on the basis of the set prohibited condition.

### <Text Generation Software>

For example, the present technology is applicable to software for text (e.g., dialogue) generation. The following examples are adoptable as a combination of choices, reward, certainty, feasibility, and condition compatibility in this case.

### (Choice)

For example, candidate text for an inquiry and candidate text for a small talk correspond to choices, and text finally presented to the user corresponds to output.

### (Reward)

For example, reward is evaluated on the basis of suitability for an inquiry.

For example, reward is evaluated on the basis of an expectation value of achievement of pleasure for the user during a small talk.

### (Certainty)

For example, certainty is evaluated on the basis of a probability that the above reward will be obtained.

For example, certainty is evaluated on the basis of presence of other similar text or the like obtained by inconsistencies of words or the like.

### (Feasibility)

For example, feasibility is evaluated on the basis of a resource available for a text generation process. For example, feasibility is evaluated on the basis of whether or not a text generation time achieved by an available resource is realistic or the like.

For example, feasibility is evaluated on the basis of accessibility. For example, feasibility is evaluated on the basis of information necessary for the text generation process, whether or not learning data or the like is accessible, or the like.

For example, feasibility is evaluated on the basis of accuracy of knowledge. For example, feasibility is evaluated on the basis of whether or not knowledge of the user or a topic is sufficient.

### (Condition Compatibility)

For example, a prohibited condition is set on the basis of viewpoints such as privacy, security, pornography, or an operation-prohibited area. For example, a prohibited condition is set on the basis of prohibited words and phrases for use, a previous conversation which has made the user uncomfortable, or the like. Thereafter, condition compatibility is evaluated on the basis of the set prohibited condition.

### <Developer Debug Software>

The present technology is also applicable to developer debug software, for example, though this application is not described in detail.

### <Software for Trial or Legal Process>

The present technology is also applicable to software for trials and legal processes, for example, though this application is not described in detail. For example, a clear explanation regarding a reason for an important judgement or a judicial decision can be presented to a person who is not an expert.

### Examples of Application to Hardware

For example, the present technology is applicable to hardware performing various processes by using AI in general. For example, the present technology is applicable to a device which automatically performs various types of processes by using AI, such as a robot, a machine tool, and an automated vehicle.

### <Control Process for Robot and Machine Tool>

For example, the present technology is applicable to a control process for a robot or a machine tool. The following examples are adoptable as a combination of choices, reward, certainty, feasibility, and condition compatibility in this case.

### (Choice)

For example, candidate actions of a robot or a machine tool correspond to choices, and an action finally executed or a result of the action finally executed corresponds to output. For example, in a case of a machine tool for holding an object, candidate actions such as catching and releasing the object correspond to choices. In a case of a robot, for example, various types of actions correspond to choices.

### (Reward)

For example, reward is evaluated on the basis of several indexes. For example, reward is evaluated on the basis of an achievement level for an input purpose. For example, reward is evaluated on the basis of an achievement level for an own purpose set by a robot or a machine tool according to circumstances.

### (Certainty)

For example, certainty is evaluated on the basis of a probability that the above reward will be obtained.

For example, certainty is evaluated on the basis of execution accuracy of an action.

### (Feasibility)

For example, feasibility is evaluated on the basis of a physical constraint. For example, a difficulty level of an action for achieving a purpose is calculated on the basis of a degree of freedom of joints of hardware, and feasibility is evaluated on the basis of the calculated difficulty level of the action. For example, feasibility is evaluated on the basis of durability of hardware.

For example, feasibility is evaluated on the basis of a resource available for an action. For example, feasibility is evaluated on the basis of whether or not an action time achieved by an available resource is realistic or the like.

### (Condition Compatibility)

For example, a prohibited condition is set on the basis of a prohibited action (e.g., an action infeasible in processes). For example, a prohibited condition is set on the basis of an action which is likely to cause an accident. Thereafter, condition compatibility is evaluated on the basis of the set prohibited condition.

Note that the present technology applied to a robot can collect information associated with an action of the robot and explain a reason or a basis for the action, for example.

### <Path Planning>

For example, the present technology is applicable to path planning. The following examples are adoptable as a combination of choices, reward, certainty, feasibility, and condition compatibility in this case.

### (Choice)

For example, candidate paths correspond to choices, and a path finally selected corresponds to output.

### (Reward)

For example, reward is evaluated on the basis of several indexes. For example, reward is evaluated on the basis of safety, a required time, a low level of uncertainty (e.g., traffic jam), or the like.

### (Certainty)

For example, certainty is evaluated on the basis of a probability that the above reward will be obtained.

### (Feasibility)

For example, feasibility is evaluated on the basis of an available resource (e.g., available traffics means).

For example, feasibility is evaluated on the basis of a physical constraint. Specifically, feasibility is evaluated on the basis of a physical constraint such as a service status of transportation means and a budget.

### (Condition Compatibility)

For example, a prohibition condition is set on the basis of a law, a traffic rule, a probability of an accident, or the like. Thereafter, condition compatibility is evaluated on the basis of the set prohibited condition.

### <Vehicle Control>

For example, the present technology is applicable to vehicle control. The following examples are adoptable as a combination of choices, reward, certainty, feasibility, and condition compatibility in this case.

### (Choice)

For example, various control parameters correspond to choices, and a parameter finally selected corresponds to output. For example, the control parameters assumed herein include control parameters for a steering wheel, control parameters for acceleration and braking, and the like.

### (Reward)

For example, reward is evaluated on the basis of several indexes. For example, reward is evaluated on the basis of comfortability, safety, a required time for reaching a destination, or the like.

### (Certainty)

For example, certainty is evaluated on the basis of a probability that the above reward will be obtained.

### (Feasibility)

For example, feasibility is evaluated on the basis of a physical constraint. Specifically, for example, feasibility is evaluated on the basis of a physical constraint such as a maximum speed of a vehicle and prohibition of turning to the right at a designated speed.

For example, feasibility is evaluated on the basis of an available resource (e.g., fuel).

### (Condition Compatibility)

For example, a prohibited condition is set on the basis of a law, a traffic law, a probability of an accident, or the like. For example, a required condition is set on the basis of selection by the user. Thereafter, condition compatibility is evaluated on the basis of the set required condition and prohibited condition.

Note that the present technology applied to a vehicle performing automated driving can present a clear explanation regarding a reason why the automated driving vehicle has conducted an action causing an accident in a case of an accident occurrence, for example.

### Other Application Examples

For example, the present technology is applicable to not only an explanation regarding a process executed by hardware and software with the use of AI, but also an explanation regarding a process performed before execution of hardware and software with the use of AI. In this case, for example, choices representing candidate processes and an explanation regarding each of the choices are presented to the user before AI performs processing. The user is allowed to select which process is to be executed by AI, for example, on the basis of the presented explanation.

For example, the present technology may be applied to determination criteria for an action performed by the user. For example, the server 111 generates choices for achieving a purpose set by the user, and evaluates the respective choices on the basis of respective selection criteria. Moreover, the server 111 generates explanatory text regarding the respective choices. Thereafter, the server 111 presents the respective choices and the explanatory text regarding the respective choices. At this time, the server 111 may also present evaluation values for the respective choices on the basis of the respective evaluation criteria. On the basis of this presentation, the user is allowed to select the choice considered to be the best choice, from the choices, with reference to the explanatory text and the like, and execute the selected choice.

### 4. Modifications

Modifications of the embodiments of the present technology described above will hereinafter be described.

### <Modification of Information Processing System>

The configuration example of the information processing system 101 described above may be modified as appropriate.

For example, process sharing between the server 111 and the user terminals 113 may be modified. For example, the user terminals 113 may carry out some or all of the processes performed by the server 111. In a case where the user terminals 113 carry out all the processes performed by the server 111, the user terminals 113 may independently execute the processes described above on the basis of information stored in the DB 112.

For example, a device operating under the control of the server 111 (e.g., robot and machine tool) may be provided instead of the user terminals 113.

For example, the server 111 may include a DB storing some or all of the pieces of information stored in the DB 112.

### <Modification of Explanatory Text>

The modal auxiliaries used in the explanatory text as described above are presented by way of example, and other modal auxiliaries may be adopted.

For example, for explanatory text regarding respective evaluation criteria, types of modal auxiliaries to be used may be changed according to evaluation values of the evaluation criteria. For example, the type of modal auxiliary to be used may be changed according to an evaluation value of reward.

For example, phrases as parts of speech other than modal auxiliaries may be adopted as phrases corresponding to the respective evaluation criteria.

For example, for explanatory text regarding respective evaluation criteria, types of templates to be used may be changed according to evaluation values of the evaluation criteria. For example, the type of template to be used may be changed according to an evaluation value of reward.

For example, explanatory text including explanation regarding multiple types of evaluation criteria may be generated by using a phrase corresponding to multiple types of evaluation criteria.

For example, the present technology is also applicable to a case of generation of explanatory text using a language other than English. For example, in a case of generation of explanatory text using Japanese, expressions such as “subeki dearu” instead of “should,” “surukamo shirenai” instead of “might,” “surukotoga dekiru” instead of “can,” and “shinakereba naranai” instead of “must” are adoptable. Moreover, for example, expressions such as “subeki denai” instead of “should not,” “shinaikamo shirenai” instead of “might not,” “surukotoga dekinai” instead of “cannot,” and “shitewa ikenai” instead of “must not” are adoptable.

### <Other Modifications>

The types of evaluation criteria are not limited to the examples described above. Addition or deletion to and from these examples may be made as appropriate.

### 5. Others

A series of the processes described above may be executed either by hardware or by software.

Note that a program executed by a computer may be either a program under which processes are executed in time series in the order described in the present description, or a program under which processes are executed in parallel or at necessary timing such as an occasion when a call is made.

In addition, the system in the present description refers to a set of multiple constituent elements (e.g., devices, modules (parts)), and does not require all constituent elements to be accommodated within an identical housing. Accordingly, multiple devices accommodated in separate housings and connected to one another via a network, and one device which has multiple modules accommodated in one housing are both defined as systems.

Moreover, embodiments according to the present technology are not limited to the embodiments described above, and may be modified in various manners within a range not departing from the subject matters of the present technology.

For example, the present technology may have a configuration of cloud computing where one function is shared by multiple devices and processed in a cooperative manner via a network.

Moreover, the respective steps described with reference to the above flowcharts may be executed by one device, or may be shared and executed by multiple devices.

Further, in a case where multiple processes are included in one step, the multiple processes included in the one step may be executed by one device, or may be shared and executed by multiple devices.

### Configuration Combination Examples

The present technology may also have the following configurations.

(1)

An information processing system including:
an evaluation portion that evaluates multiple choices according to two or more evaluation criteria based on parameters obtained during a process or a result of machine learning; and
an explanation portion that generates explanatory text regarding each of the choices by using a phrase associated with a corresponding one of the evaluation criteria.
   (2)

The information processing system according to (1) above, in which the explanation portion generates the explanatory text regarding each of the evaluation criteria according to an evaluation based on a corresponding one of the evaluation criteria.

(3)

The information processing system according to (2) above, in which
the phrase includes a modal auxiliary associated with a corresponding one of the evaluation criteria, and
the explanation portion generates the explanatory text regarding each of the evaluation criteria by using the modal auxiliary associated with the corresponding evaluation criterion.
   (4)

The information processing system according to (3) above, in which the explanation portion sets a use method of the modal auxiliary associated with the corresponding evaluation criterion according to the evaluation based on the corresponding evaluation criterion.

(5)

The information processing system according to (3) or (4) above, in which
the evaluation criteria include two or more of reward, certainty, feasibility, and condition compatibility,
the modal auxiliary corresponding to the reward includes “should,”
the modal auxiliary corresponding to the certainty includes “might,”
the modal auxiliary corresponding to the feasibility includes “can,” and
the modal auxiliary corresponding to the condition compatibility includes “must.”
   (6)

The information processing system according to any one of (2) to (5) above, in which the explanation portion generates the explanatory text regarding each of the evaluation criteria by using a template associated with a corresponding one of the evaluation criteria.

(7)

The information processing system according to any one of (1) to (6) above, further including:
a selection portion that selects output from among the choices according to an evaluation based on a corresponding one of the evaluation criteria.
   (8)

The information processing system according to (7) above, in which the explanation portion generates the explanatory text regarding the output.

(9)

The information processing system according to (8) above, in which the explanation portion further generates the explanatory text regarding the choice not selected.

(10)

The information processing system according to any one of (7) to (9) above, in which the evaluation criteria include two or more of reward, certainty, feasibility, and condition compatibility.

(11)

The information processing system according to (10) above, in which the selection portion gives priority to the condition compatibility to select the output.

(12)

The information processing system according to any one of (1) to (11) above, further including:
a presentation control portion that controls presentation of the explanatory text.
   (13)

The information processing system according to (12) above, further including:
a selection portion that selects output from among the choices according to an evaluation based on a corresponding one of the evaluation criteria, in which
the presentation control portion controls presentation of a selection result of the output and the explanatory text.
   (14)

The information processing system according to (13) above, in which the presentation control portion performs control such that the explanatory text is presented in response to an inquiry from a user after the presentation of the selection result of the output.

(15)

The information processing system according to any one of (1) to (14) above, further including:
a learning portion that performs reinforcement learning to generate an evaluation function for evaluating the choices on the basis of the respective evaluation criteria, in which
the evaluation portion evaluates the choices by using the evaluation function.
   (16)

The information processing system according to any one of (1) to (15) above, further including:
a choice generation portion that generates the multiple choices each indicating a method for achieving a purpose, on the basis of information regarding the purpose and a subject of the purpose.
   (17)

The information processing system according to any one of (1) to (16) above, in which the phrase includes a modal auxiliary associated with a corresponding one of the evaluation criteria.

(18)

An information processing method performed by an information processing system, the information processing method including:
evaluating multiple choices according to two or more evaluation criteria based on parameters obtained during a process or a result of machine learning; and
generating explanatory text regarding each of the choices by using a phrase associated with a corresponding one of the evaluation criteria.
   (19)

A program for causing a computer to execute a process including steps of:
evaluating multiple choices according to two or more evaluation criteria based on parameters obtained during a process or a result of machine learning; and
generating explanatory text regarding each of the choices by using a phrase associated with a corresponding one of the evaluation criteria.

Note that advantageous effects to be offered are not limited to those presented in the present description only by way of example. Other advantageous effects may be produced.

### REFERENCE SIGNS LIST

101: Information processing system
111: Server
112: DB
113-1 to 113-n: User terminal
151: CPU
171: CPU
172: Communication control section
181: Learning portion
182: Choice generation portion
183: Evaluation portion
184: Selection portion
185: Explanation portion
186: Presentation control portion

1. An information processing system comprising:
an evaluation portion that evaluates multiple choices according to two or more evaluation criteria based on parameters obtained during a process or a result of machine learning; and
an explanation portion that generates explanatory text regarding each of the choices by using a phrase associated with a corresponding one of the evaluation criteria.

2. The information processing system according to claim 1, wherein the explanation portion generates the explanatory text regarding each of the evaluation criteria according to an evaluation based on a corresponding one of the evaluation criteria.

3. The information processing system according to claim 2, wherein
the phrase includes a modal auxiliary associated with a corresponding one of the evaluation criteria, and
the explanation portion generates the explanatory text regarding each of the evaluation criteria by using the modal auxiliary associated with the corresponding evaluation criterion.

4. The information processing system according to claim 3, wherein the explanation portion sets a use method of the modal auxiliary associated with the corresponding evaluation criterion according to the evaluation based on the corresponding evaluation criterion.

5. The information processing system according to claim 3, wherein
the evaluation criteria include two or more of reward, certainty, feasibility, and condition compatibility,
the modal auxiliary corresponding to the reward includes “should,”
the modal auxiliary corresponding to the certainty includes “might,”
the modal auxiliary corresponding to the feasibility includes “can,” and
the modal auxiliary corresponding to the condition compatibility includes “must.”

6. The information processing system according to claim 2, wherein the explanation portion generates the explanatory text regarding each of the evaluation criteria by using a template associated with a corresponding one of the evaluation criteria.

7. The information processing system according to claim 1, further comprising:
a selection portion that selects output from among the choices according to an evaluation based on a corresponding one of the evaluation criteria.

8. The information processing system according to claim 7, wherein the explanation portion generates the explanatory text regarding the output.

9. The information processing system according to claim 8, wherein the explanation portion further generates the explanatory text regarding the choice not selected.

10. The information processing system according to claim 7, wherein the evaluation criteria include two or more of reward, certainty, feasibility, and condition compatibility.

11. The information processing system according to claim 10, wherein the selection portion gives priority to the condition compatibility to select the output.

12. The information processing system according to claim 1, further comprising:
a presentation control portion that controls presentation of the explanatory text.

13. The information processing system according to claim 12, further comprising:
a selection portion that selects output from among the choices according to an evaluation based on a corresponding one of the evaluation criteria, wherein
the presentation control portion controls presentation of a selection result of the output and the explanatory text.

14. The information processing system according to claim 13, wherein the presentation control portion performs control such that the explanatory text is presented in response to an inquiry from a user after the presentation of the selection result of the output.

15. The information processing system according to claim 1, further comprising:
a learning portion that performs reinforcement learning to generate an evaluation function for evaluating the choices on a basis of the respective evaluation criteria, wherein
the evaluation portion evaluates the choices by using the evaluation function.

16. The information processing system according to claim 1, further comprising:
a choice generation portion that generates the multiple choices each indicating a method for achieving a purpose, on a basis of information regarding the purpose and a subject of the purpose.

17. The information processing system according to claim 1, wherein the phrase includes a modal auxiliary associated with a corresponding one of the evaluation criteria.

18. An information processing method performed by an information processing system, the information processing method comprising:
evaluating multiple choices according to two or more evaluation criteria based on parameters obtained during a process or a result of machine learning; and
generating explanatory text regarding each of the choices by using a phrase associated with a corresponding one of the evaluation criteria.

19. A program for causing a computer to execute a process comprising steps of:
evaluating multiple choices according to two or more evaluation criteria based on parameters obtained during a process or a result of machine learning; and
generating explanatory text regarding each of the choices by using a phrase associated with a corresponding one of the evaluation criteria.
